(19) United States
(12) Patent Application Publication
(10) Pub. No.: US 2023/0109192 A1
(43) Pub. Date: Apr. 6, 2023

(54) CO2 CAPTURE SYSTEM

(71) Applicant: TOYOTA JIDOSHA KABUSHIKI KAISHA, Aichi-ken (JP)

(72) Inventors: Koseki SUGIYAMA, Shizuoka-ken (JP); Daiki YOKOYAMA, Gotemba-shi (JP)

(21) Appl. No.: 17/938,023

(22) Filed: Oct. 4, 2022

(30) Foreign Application Priority Data
Oct. 5, 2021 (JP) 2021-164015

(51) Int. Cl. B01D 53/30; B01D 53/62

(52) U.S. Cl. CPC B01D 53/30; B01D 53/62; B01D 2257/504; B01D 2259/4508; B01D 2258/02

(57) ABSTRACT

A CO2 capture system for efficiently capturing CO2 from emissions emitted from buildings. The CO2 capture system comprises: a CO2 capture device that captures CO2; a flow path that delivers an exhaust gas emitted from a building to the CO2 capture device; a flow rate regulator that regulates a flow rate of the exhaust gas; and a control unit that controls the flow rate regulator to regulate the flow rate of the exhaust gas.

### CROSS-REFERENCE TO RELATED APPLICATIONS

The present disclosure claims the benefit of Japanese Patent Application No. 2021-164015 filed on Oct. 5, 2021 with the Japanese Patent Office.

### BACKGROUND

### Field of the Invention

Embodiments of the present disclosure relate to the art of a CO2 capture system that captures CO2 emitted into the atmosphere and stores the captured CO2.

### Discussion of the Related Art

JP-A-2011-038667 describes an oxygen combustion plant employed in e.g., a thermal energy plant, and an operating method thereof. The oxygen combustion plant described in JP-A-2011-038667 comprises: a combustion device for burning oxygen, combustion exhaust gas and fuel; a carbon dioxide recovering device for recovering carbon dioxide from the produced combustion exhaust gas; a pipeline for transferring carbon dioxide to an another place; a carbon dioxide pushing-out line for distributing carbon dioxide to the pipeline; and a carbon dioxide taking-in line for guiding carbon dioxide from the pipeline to the oxygen combustion plant. In addition, on-off valves are disposed on the carbon dioxide pushing-out line and the carbon dioxide taking-in line. According to the teachings of JP-A-2011-038667, the on-off valves are manipulated in accordance with an operating condition of the oxygen combustion plant and a concentration of oxygen in the oxygen combustion plant. According to the teachings of JP-A-2011-038667, therefore, a starting time of the oxygen combustion plant may be reduced, and an amount of carbon dioxide released to the outside of the oxygen combustion plant may be reduced.

As described, the teachings of JP-A-2011-038667 may be applied to a thermal energy plant that generates electricity using a steam turbine. In the power plant of this kind, in order to reduce CO2 emissions, CO2 resulting from combusting fuel and air (i.e., oxygen) is collected by a CO2 recovering device and stored in a reservoir.

CO2 as one of factors of global warming is also emitted from manufacturing plants, housings, shops, restaurants, factories, offices, and so on. In order to prevent global warming, CO2 emissions from those buildings may be reduced by sending the air emitted from those buildings to e.g., the carbon dioxide recovering device described in JP-A-2011-038667 thereby separating the CO2 from the air to collect CO2. However, CO2 emissions from those buildings vary by time of day and the seasons of the year. Therefore, the CO2 may not be captured efficiently if the emission (i.e., air) from those buildings is delivered to the carbon dioxide recovering device in a constant manner.

### SUMMARY

Aspects of embodiments of the present disclosure have been conceived noting the foregoing technical problems, and it is therefore an object of the present disclosure to provide a CO2 capture system for efficiently capturing CO2 from emissions emitted from buildings and housings.

According to the present disclosure, there is provided a CO2 capture system, comprising: a CO2 capture device that separates and captures CO2 from air; a plurality of buildings; and a flow path that delivers an exhaust gas emitted from the building to the CO2 capture device to capture the CO2 from the exhaust gas by the CO2 capture device. In order to achieve the above-explained objective, according to the present disclosure, the CO2 capture system is provided with: a flow rate regulator that regulates a flow rate of the exhaust gas flowing from the building toward the CO2 capture device through the flow path; and a control unit that controls the flow rate regulator to regulate the flow rate of the exhaust gas.

In a non-limiting embodiment, the control unit may be configured to: collect information relating to a concentration of the CO2 in the exhaust gas emitted from the building; and control the flow rate regulator based on the collected information.

In a non-limiting embodiment, the CO2 capture system may further comprise a detector that collects behavioral data of occupants of the building including the number of people coming in and out of the building and behavior of the people in the building. In addition, the control unit may be further configured to: receive the behavioral data of the occupants of the building; and regulate the flow rate of the exhaust gas based on the behavioral data.

In a non-limiting embodiment, the control unit may be further configured to increase the flow rate of the exhaust gas with an increase in the number of the occupants of the building.

In a non-limiting embodiment, the control unit may be further configured to increase the flow rate of the exhaust gas during a period of time in which the number of the occupants of the building is large, compared to a period of time in which the number of the occupants of the building is small.

In a non-limiting embodiment, the control unit may be further configured to stop a delivery of the exhaust gas from the building to the CO2 capture device when nobody is in the building.

In a non-limiting embodiment, the control unit may be further configured to: estimate the concentration of the CO2 in the exhaust gas emitted from the building based on the behavioral data of the occupants of the building; and increase the flow rate of the exhaust gas with an increase in the concentration of the CO2 in the exhaust gas.

In a non-limiting embodiment, the CO2 capture system may further comprise a CO2 sensor that detects a concentration of the CO2 in the exhaust gas emitted from the building. In addition, the control unit may be further configured to increase the flow rate of the exhaust gas with an increase in the concentration of the CO2 in the exhaust gas detected by the CO2 sensor.

In a non-limiting embodiment, the flow rate regulator may include a valve disposed between the building and the CO2 capture device. In addition, the control unit may be further configured to regulate the flow rate of the exhaust gas by manipulating the valve.

In a non-limiting embodiment, the flow rate regulator may include a blower disposed between the building and the CO2 capture device. In addition, the control unit may be further configured to regulate the flow rate of the exhaust gas by controlling a wind created by the blower.

In a smart city, CO2 is emitted not only from cooking appliances and heating equipment in the buildings but also from occupants breathing in the buildings, and CO2 contained in the exhaust gases emitted from is captured by the CO2 capture system. However, CO2 emissions from the buildings vary by time of day and the seasons of the year. Therefore, the CO2 may not be captured efficiently if the exhaust gases emitted from the buildings are delivered to the CO2 capture device in a constant manner. For example, if a concentration of CO2 in the exhaust gas is low, an amount of CO2 captured by the CO2 capture device with respect to an energy consumed to operate the CO2 capture device would be reduced. In order to avoid such disadvantage, according to the exemplary embodiment of the present disclosure, the flow rate regulator is disposed between each of the buildings and the CO2 capture device to regulate a flow rate of the exhaust gas flowing from the building toward the CO2 capture device. According to the exemplary embodiment of the present disclosure, therefore, the flow rate of the exhaust gas delivered to the CO2 capture device can be adjusted in accordance with e.g., a concentration of CO2 in the exhaust gas.

To this end, the control unit collects information relating to a concentration of CO2 contained in the exhaust gas, and regulates a flow rate of the exhaust gas being delivered to the CO2 capture device based on the collected information. For example, in order to obtain the concentration of CO2 in the exhaust gas emitted from the building, the control unit collects information about the number of occupants of the building. Instead, the concentration of CO2 in the exhaust gas may also be detected directly by the CO2 sensor. Therefore, when a concentration of CO2 in the exhaust gas is low, the flow rate of the exhaust gas delivered to the CO2 capture device may be reduced based on the collected information.

As described, the CO2 capture system according to the exemplary embodiment of the present disclosure comprises the detector including a monitoring camera, a human detecting sensor a mobile terminal etc. For example, in a case that that the monitoring camera is adopted as the detector, the control unit 8 determines that the concentration of CO2 in the exhaust gas is high if the number of people in the building detected by the monitoring camera is large. Otherwise, in a case that that the mobile terminal carried by the occupant of the building is adopted as the detector, the control unit 8 determines that the concentration of CO2 in the exhaust gas is high if the number of people carrying the mobile terminals in the building is large. Further, the number of people in the building may also be detected utilizing a scheduling function of the mobile terminal. According to the exemplary embodiment of the present disclosure, therefore, the flow rate of the exhaust gas delivered to the CO2 capture device may be regulated based on a detection value or a predicted value of the number of people in the building.

According to the exemplary embodiment of the present disclosure, specifically, the flow rate of the exhaust gas delivered to the CO2 capture device is increased with an increase in the number of people in the building. Otherwise, when nobody is in the building, the control unit determines that the concentration of CO2 in the exhaust gas is low, and stops the delivery of the exhaust gas to the CO2 capture device.

According to the exemplary embodiment of the present disclosure, the concentration of CO2 in the exhaust gas emitted from the building may also be detected directly by the CO2 sensor. For example, the flow rate of the exhaust gas delivered to the CO2 capture device is increased with an increase in the concentration of CO2 in the exhaust gas detected by the CO2 sensor. Otherwise, when the concentration of CO2 in the exhaust gas detected by the CO2 sensor detected by the CO2 sensor is less than a predetermined value, the control unit stops the delivery of the exhaust gas to the CO2 capture device. Thus, according to the exemplary embodiment of the present disclosure, the flow rate of the exhaust gas delivered to the CO2 capture device may be regulated in accordance with an actual concentration of CO2 in the exhaust gas detected directly by the CO2 sensor.

As also described, according to the exemplary embodiment of the present disclosure, the flow rate regulator includes the valve and blower. According to the exemplary embodiment of the present disclosure, therefore, the flow rate of the exhaust gas delivered to the CO2 capture device may be regulated by controlling an opening degree of the valve or a wind created by the blower.

Thus, according to the exemplary embodiment of the present disclosure, the CO2 capture device may be operated in an efficient manner taking account of a concentration of CO2 in the exhaust gas emitted from the building. According to the exemplary embodiment of the present disclosure, therefore, CO2 may be captured efficiently from the exhaust gasses emitted from the buildings by the CO2 capture device.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is an illustrative drawing showing one example of a structure of the CO2 capture system according to the present disclosure.

FIG. 2 is an showing another example of a structure of the CO2 capture system according to the present disclosure.

FIG. 3 is a flowchart showing one example of a routine to control a flow rate of an exhaust gas flowing toward a CO2 capture device in accordance with the time;

FIG. 4 is a flowchart showing one example of a routine to collect behavioral data of occupants of a building that is used to estimate a concentration of CO2 in the exhaust gas emitted from the building;

FIG. 5 is a flowchart showing one example of a routine to directly detect a concentration of CO2 in the exhaust gas emitted from the building;

FIG. 6 is a flowchart showing one example of a routine to regulate a flow rate of the exhaust gas flowing toward the CO2 capture device based on information about a concentration of CO2 in the exhaust gas;

FIG. 7 is a flowchart showing one example of a routine to save data about the concentration of CO2 in a database; and

FIG. 8 is a flowchart showing one example of a routine to regulate a flow rate of the exhaust gas flowing toward the CO2 capture device based on the data stored in the database.

### DETAILED DESCRIPTION OF THE PREFERRED EMBODIMENT(S)

Embodiments of the present disclosure will now be explained with reference to the accompanying drawings. Note that the embodiments shown below are merely examples of the present disclosure which should not limit a scope of the present disclosure.

The CO2 capture system according to the exemplary embodiment of the present disclosure is configured to capture CO2 from an exhaust gas emitted from housings and buildings in a predetermined area such as a “smart city”.

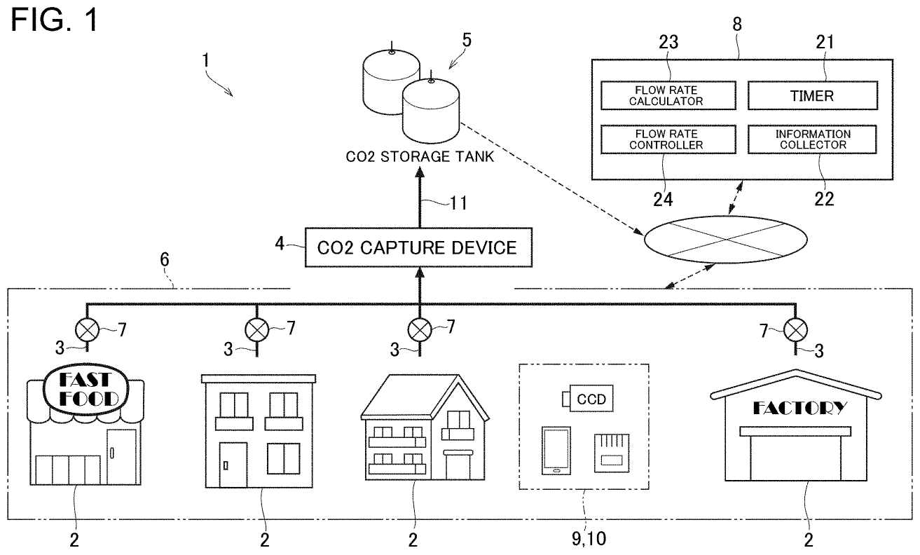

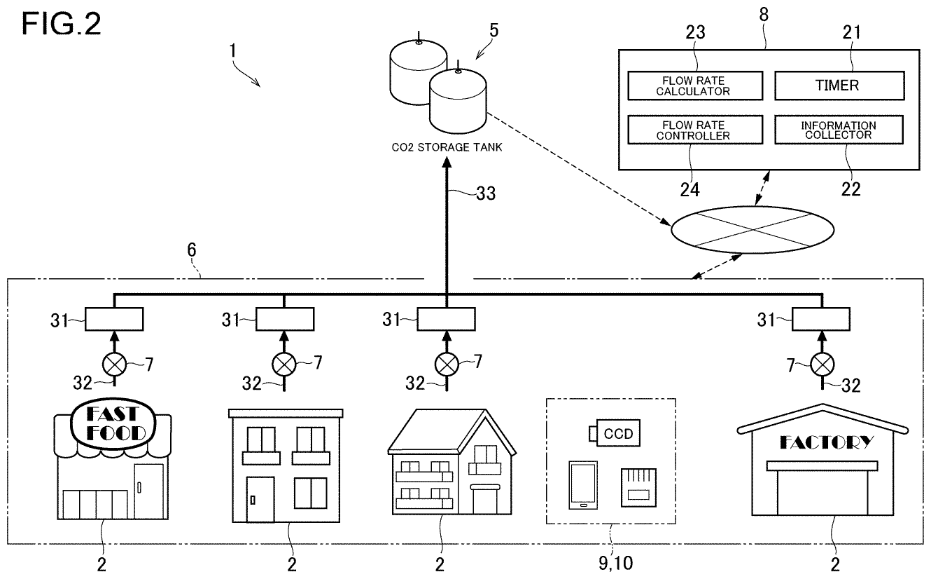

Turning to FIG. 1, there is shown one example of the CO2 capture system 1 according to the exemplary embodiment of the present disclosure. As illustrated in FIG. 1, in the CO2 capture system 1, air and exhaust gas emitted from a building 2 is delivered to a CO2 capture device 4 through a flow path 3, and CO2 contained in the air and the exhaust gas is separated and captured by the CO2 capture device 4. The CO2 captured by CO2 capture device 4 is delivered to a CO2 storage tank 5. In FIG. 2, specifically, there is depicted an example to capture the CO2 emitted from the buildings 2 in the smart city 6 intensively by the CO2 capture device 4. The CO2 capture system 1 comprises: a flow rate regulator 7 that regulates a flow rate of the exhaust gas flowing from the building 2 toward the CO2 capture device 4; a control unit 8 that controls the flow rate regulator 7; a CO2 sensor 9 that detects a concentration of the CO2 contained in the exhaust gas emitted from the building 2; and a detector 10 that collects data about occupants of the building 2 e.g., the number of residents in the building 2, the number of people coming in and out of the building 2, and behavior of the people in the building 2.

The building 2 includes a housing, a shop, a restaurant, a factory, a hospital, a warehouse and so on located in the smart city 6. For example, CO2 is emitted from a relatively small building 2 such as a housing, a shop, an office, or the like by breathing of occupants. In addition, CO2 is also emitted from heating equipment and cooking appliances in the building 2. Therefore, the CO2 capture system 1 according to the exemplary embodiment of the present disclosure is configured to capture CO2 mainly from the buildings 2 of small or medium size.

Outlets (not shown) of the buildings 2 are individually connected to an inlet (not shown) of the CO2 capture device 4 through the flow paths 3 as vent pipes so that air containing CO2 is delivered from the buildings 2 to the CO2 capture device 4 through the flow paths 3.

As described, the CO2 capture device 4 captures CO2 from the air and the exhaust gas delivered thereto from the buildings 2 through the flow paths 3. In addition, the CO2 capture device 4 is adapted to communicate with the control unit 8 through dedicated communication lines or public communication lines so that data can be exchanged between the CO2 capture device 4 and the control unit 8.

For example, CO2 may be captured by the CO2 capture device 4 utilizing principles of physical adsorption, physical absorption, chemical adsorption, and cryogenic distillation as disclosed in JP-A-2021-8852. Specifically, in a case of employing the physical adsorption method, CO2 is captured by contacting the exhaust gas with a solid adsorbent such as an activated carbon and zeolite, and then heating or depressurizing the solid adsorbent to desorb the CO2 from the solid adsorbent. In a case of employing the physical absorption method, CO2 is captured by contacting the exhaust gas with an absorbing liquid for dissolving the CO2 such as methanol and ethanol thereby physically absorbing the CO2 into the absorbing liquid under high pressure at a low temperature, and then heating or depressurizing the absorbing liquid to collect the CO2 from the absorbing liquid. In a case of employing the chemical adsorption method, CO2 is captured by contacting the exhaust gas with an absorbing liquid for selectively dissolving the CO2 such as amine thereby chemically absorbing the CO2 into the absorbing liquid, and then heating the absorbing liquid to collect the CO2 from the absorbing liquid. In a case of employing the cryogenic distillation method, CO2 is captured by compressing and cooling exhaust gas to liquidize CO2 contained therein, and selectively distilling the liquidized CO2 to collect the CO2.

The CO2 capture device 4 is connected to the CO2 storage tank 5 through a flow path 11 so that the CO2 captured by the CO2 capture device 4 is stored in the CO2 storage tank 5. Specifically, an outlet (not shown) of the CO2 capture device 4 is connected to an inlet (not shown) of the CO2 storage tank 5 through the flow path 11 as a piping so that the CO2 captured by the CO2 capture device 4 is allowed to flow through the flow path 11 not only in the liquid phase but also in the gaseous phase depending on the capturing method. The CO2 storage tank 5 is also adapted to communicate with the control unit 8 through the dedicated communication lines or public communication lines (neither of which are shown) so that data can be exchanged between the CO2 storage tank 5 and the control unit 8. For example, data relating to a reserve of the CO2 and an available storage in the CO2 storage tank 5 are sent from the CO2 storage tank 5 to the control unit 8. If the available storage in the CO2 storage tank 5 is small, the control unit 8 restricts an entrance of the exhaust gas from the buildings 2 to the CO2 capture device 4 by manipulating the flow rate regulator 7.

According to the exemplary embodiment of the present disclosure, the CO2 capture system 1 is applied to the smart city 6 in which the buildings 2 are located. The definition of the “smart city” is defined by the Ministry of Land, Infrastructure, Transport and Tourism of the Japanese government, as a sustainable city or region where various problems are solved by improving management (e.g., planning, development, operation) while utilizing ICT (Information and Communication Technology). In the smart city 6, CO2 emitted from the buildings 2 is captured by the CO2 capture device 4, and the CO2 captured by the CO2 capture device 4 may be recycled into fuel. That is, CO2 may be circulated within the smart city to reduce CO2 emission from the smart city 6.

For example, a valve mechanism such as a flow control valve and an on-off valve may be adopted as the flow rate regulator 7. In a case of employing the flow control valves as the flow rate regulators 7, a flow rate of the CO2 between each of the buildings 2 and the CO2 capture device 4 is regulated in accordance with opening degrees of the flow control valves. Whereas, in a case of employing the on-off valves as the flow rate regulators 7, each of the flow paths 3 is selectively opened and closed by switching positions of valve elements in the on-off valves. In addition, a shutter arranged in e.g., a ventilating fan may also be employed as the flow rate regulator 7 instead of the above-mentioned valves. Thus, in the CO2 capture system 1 according to the exemplary embodiment of the present disclosure, flow rates of the exhaust gases delivered to the CO2 capture device 4 from the buildings 2 may be regulated by the flow rate regulators 7.

Instead, a blower may also be adopted as the flow rate regulator 7. In this case, a flow rate of the exhaust gas flowing through the flow path 3 toward the CO2 capture device 4 is changed in accordance with a blast of wind created by the blower. In the CO2 capture system 1, both of the valves and the blowers may also be employed together to serve as the flow rate regulators 7. The flow rate regulators 7 are also adapted to communicate with the control unit 8 through the dedicated communication lines or public communication lines so that data can be exchanged between each of the flow rate regulators 7 and the control unit 8.

Specifically, the control unit 8 as a main controller of the CO2 capture system 1 is an electronic control unit comprising a microcomputer or a server computer. For example, the control unit 8 controls the flow rate regulators 7 thereby regulating flow rates of CO2 delivered from the buildings 2 to the CO2 capture device 4. To this end, the control unit 8 is connected to an external server and websites on the internet through dedicated communication lines or public communication lines (neither of which are shown). In addition, various kinds of data collected by e.g., the CO2 sensor 9 and the detector 10 are transmitted to the control unit 8.

The CO2 sensor 9 directly detects a concentration of CO2 in the exhaust gas emitted from the building 2. To this end, for example, the CO2 sensor 9 may be arranged in the vicinity of the outlet of the building 2, and in the flow path 3 between the building 2 and the flow rate regulator 7.

The detector 10 collects data relating to the number of people coming in and out of the building 2, and data relating to behavior of the people in the building 2. To this end, for example, a monitoring camera (or security camera) and a human detecting sensor may be adopted as the detector 10 to observe the people coming in and out of the building 2. Based on the number of people detected by the detector 10, the control unit 8 estimates a concentration of CO2 in the exhaust gas emitted from the building 2. Specifically, if the number of people in the building 2 is large, the control unit 8 determines that the concentration of CO2 in the exhaust gas is high. Instead, a mobile terminal (not shown) such as a mobile phone, a personal computer, an electronic databook or the like carried by the people coming in and out of the building 2 may also be adopted as the detector 10. In this case, for example, the detector 10 collects data relating to the number of people coming in and out of the building 2 and behavior of the people in the building 2 utilizing a scheduling function. Specifically, schedules of the people coming in and out of the building 2 to transfer to the other place from the building 2 or to come back to the building 2 are collected by the detector 10. Based on the data collected by the detector 10, the control unit 8 predicts time of day at which the number of people in the building 2 is large. At the time when the number of people in the building 2 is expected to be large, the control unit 8 predicts that the concentration of CO2 in the exhaust gas emitted from the building 2 will be increased higher than that at the time when the number of people in the building 2 is small.

The control unit 8 is configured to perform calculation based on the incident data and data and formulas stored therein, and to transmit calculation result to in the form of command signal. For example, in order to regulate a flow rate of the exhaust gas delivered from the building 2 to the CO2 capture device 4, the control unit 8 transmits command signals to the flow rate regulator 7 so as to control an opening degree of the flow rate regulator 7 or to open or close the flow rate regulator 7. Otherwise, given that the blower is employed as the flow rate regulator 7, the control unit 8 controls the wind created by the flow rate regulator 7.

Specifically, the control unit 8 comprises a timer 21, an information collector 22, a flow rate calculator 23, and a flow rate controller 24.

The timer 21 collects information about a time required to commence the control of a flow rate of CO2 such as a time of day, a control time, an elapsed time etc. For example, the timer 21 collects data about time of day at which the number of people in the building 2 is large or small. Based on the information collected by the timer 21, the control unit 8 determines time of day at which a concentration of CO2 in the exhaust gas emitted from the building 2 is high or low. In addition, the control unit 8 determines a timing and intervals to execute the control of a flow rate of CO2 based on the information collected by the timer 21.

The information collector 22 collects various kinds of data to control a flow rate of CO2. Specifically, the information collector 22 obtains data about a concentration of CO2 in the exhaust gas emitted from the building 2 based on the data collected by the CO2 sensor 9. In addition, the information collector 22 obtains data about the number of people in the building 2 and behavior of the people in the building 2 based on the data collected by the detector 10. Otherwise, the information collector 22 may obtain data about the number of people in the building 2 also based on video data collected by the camera or data collected by a sensor (not shown).

The flow rate calculator 23 calculates a flow rate of the exhaust gas delivered from each of the buildings 2 to the CO2 capture device 4 based on the data collected by the timer 21 and the information collector 22. For example, in a case that a concentration of CO2 in the exhaust gas emitted from the building 2 is low, a flow rate of the exhaust gas delivered to the CO2 capture device 4 is reduced compared to that of a case in which a concentration of CO2 in the exhaust gas emitted from the building 2 is high. Whereas, in a case that the number of people in the building 2 is large, the control unit 8 estimates that the concentration of CO2 in the exhaust gas in the exhaust gas emitted from the building 2 is higher than that of a case in which the number of people in the building 2 is small. In this case, the flow rate of the exhaust gas delivered to the CO2 capture device 4 is increased.

The flow rate controller 24 controls the flow rate regulator 7 based on the flow rate of the exhaust gas delivered from the building 2 to the CO2 capture device 4 calculated by the flow rate calculator 23. For example, given that the valve is adopted as the flow rate regulator 7, the flow rate controller 24 opens or closes the flow rate regulator 7, or controls an opening degree of the flow rate regulator 7 based on the flow rate of the exhaust gas calculated by the flow rate calculator 23. Otherwise, given that the blower is adopted as the flow rate regulator 7, the flow rate controller 24 controls the wind created by the flow rate regulator 7.

Although only one control unit 8 is arranged in the CO2 capture system 1 shown in FIG. 1, a plurality of control units may be arranged in the CO2 capture system 1 to control each building and device individually. As an option, each of the flow rate regulators 7 may be provided with its own dedicated computer (not shown). In this case, the control unit 8 includes those computers and a main server (not shown) installed on a predetermined site.

The CO2 capture device 4 may also be arranged in each of the buildings 2. Turning to FIG. 2, there is shown an example of arranging a CO2 capture device 31 in each of the buildings 2 in the smart city so as to capture CO2 individually from the exhaust gas emitted from each of the buildings 2. In the CO2 capture system 1 shown in FIG. 2, common reference numerals are assigned to the elements in common with those shown in FIG. 1.

Each of the CO2 capture devices 31 has a same function as the CO2 capture device 4 of the foregoing example. According to the example shown in FIG. 2, the flow rate regulators 7 are arranged on flow paths 32 connecting the buildings 2 to the CO2 capture devices 31. Specifically, the exhaust gas containing CO2 that is emitted from the building 2 flows through the flow path 32 toward the CO2 capture device 31 via the flow rate regulator 7. The CO2 in the exhaust gas delivered to the CO2 capture device 31 is separated and captured by the CO2 capture device 31, and then, delivered from the CO2 capture device 31 to the CO2 storage tank 5 through a flow path 33 not only in the liquid phase but also in the gaseous phase depending on the capturing method.

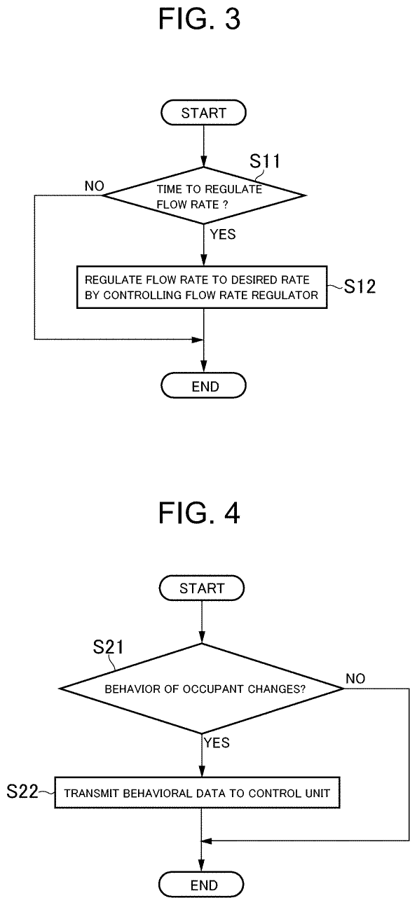

As described, the CO2 capture system according to the exemplary embodiment of the present disclosure is configured to capture CO2 efficiently from the exhaust gas emitted from the buildings 2. To this end, the control unit 8 executes routines shown in FIGS. 3 to 8.

Turning to FIG. 3, there is shown an example of the routine to control a flow rate of the exhaust gas delivered from the building 2 to the CO2 capture device 4 or 31 in accordance with the time taking account of a concentration of CO2 in the exhaust gas. At step S11, it is determined whether it is time to regulate a flow rate of the exhaust gas delivered from the buildings 2 to the CO2 capture device 4 or 31. Specifically, the time to regulate the flow rate is set to (a period of) time at which a concentration of CO2 in the exhaust gas emitted from the building 2 is (expected to be) changed. For example, given that the building 2 is a shop or restaurant, it is determined at step S1 whether it is the opening time of the shop or restaurant. In this case, after the opening time of the shop or restaurant, the control unit 8 estimates that the number of people in the shop or restaurant increases, and a concentration of CO2 in the exhaust gas emitted from the shop or restaurant will be increased. Whereas, given that the building 2 is a housing, it is determined at step S11 whether it is (average) time for the resident(s) to go to work or school, or whether it is about time that the resident(s) comes back to the building 2. In this case, after the time for the resident(s) to go to work or school, the control unit 8 estimates that the number of people in the building 2 decreases, and a concentration of CO2 in the exhaust gas emitted from the building 2 will be reduced.

If the current time is before the time to regulate the flow rate so that the answer of step S11 is NO, the routine returns. By contrast, if it is time to regulate the flow rate of the exhaust gas so that the answer of step S11 is YES, the routine progresses to step S12 to control the flow rate regulator 7 so as to regulate the flow rate of the exhaust gas being delivered to the CO2 capture device 4 or 31 to a desired rate.

At step S12, specifically, an opening degree of the valve or a wind created by the blower is adjusted to regulate the flow rate of the exhaust gas being delivered to the CO2 capture device 4 or 31 to a desired rate. For example, if it is time to open the shop, the flow rate regulator 7 is controlled in such a manner as to increase a flow rate of the exhaust gas flowing toward the CO2 capture device 4 or 31. By contrast, if it is time for the residents of the building 2 to go to work, the flow rate regulator 7 is controlled in such a manner as to reduce a flow rate of the exhaust gas flowing toward the CO2 capture device 4 or 31.

In addition, when CO2 emission from the occupants of the building 2 is substantially zero, for example, when nobody is in the housing in the daytime or when nobody is in the office in the nighttime, the delivery of the exhaust gas to the CO2 capture device 4 or 31 may be stopped by controlling the flow rate regulator 7.

After controlling the flow rate regulator 7 to regulate the flow rate of the exhaust gas being delivered to the CO2 capture device 4 or 31 to the desired rate, the routine returns.

Thus, the flow rate of the exhaust gas being delivered to the CO2 capture device 4 or 31 is regulated to the desired rate when the concentration of CO2 in the exhaust gas is expected to change. For example, when the number of occupants in the building 2 is large, the flow rate of the exhaust gas being delivered to the CO2 capture device 4 or 31 is increased compared to that of the case in which the number of occupants in the building 2 is small. Otherwise, when nobody is in the building 2 the delivery of the exhaust gas to the CO2 capture device 4 or 31 is stopped. That is, the flow rate of the exhaust gas being delivered to the CO2 capture device 4 or 31 is reduced to zero. According to the exemplary embodiment of the present disclosure, therefore, a large amount of the exhaust gas in which a concentration of CO2 is high may be delivered to the CO2 capture device 4 or 31. In other words, a delivery amount of the exhaust gas in which a concentration of CO2 is low to the CO2 capture device 4 or 31 is reduced. For this reason, CO2 may be captured by the CO2 capture device 4 or 31 efficiently from the exhaust gas emitted from the building 2.

Turning to FIG. 4, there is shown an example of the routine to collect behavioral data of the people coming in and out of the building 2 that is used to estimate a concentration of CO2 in the exhaust gas emitted from the building 2. For example, the routine shown in FIG. 4 is executed by the by the detector 10 such as a mobile terminal, and a microcomputer (not shown) arranged in or interfacing with a monitoring camera. At step S21, it is determined whether the behavior of the occupant(s) of the building 2 changes, based on the behavioral data collected by the detector 10. For example, the behavioral data of the occupant may be collected based on a location information of the mobile terminal carried by the occupant, and the detector 10 determines that the behavior of the occupant changes when the occupant enters the building 2. By contrast, when the occupant goes out of the building 2, the detector 10 also determines that the behavior of the occupant changes. In addition, the number of occupants of the building 2 is detected as the behavioral data by the monitoring camera installed in the building 2, and the detector 10 determines that the behavior of the occupant changes when the number of occupants of the building 2 changes.

If the number of the occupant(s) of the building 2 has not yet changed so that the answer of step S21 is NO, the routine returns. By contrast, if the number of the occupant(s) of the building 2 changes so that the answer of step S21 is YES, the routine progresses to step S22 to transmit the behavioral data detected at step S21 to the control unit 8.

At step S22, specifically, the behavioral data such as the number of occupants carrying the mobile terminals is transmitted from the mobile terminals to the information collector 22 of the control unit 8. Instead, the behavioral data such as the number of occupants is transmitted from the monitoring camera to the information collector 22 of the control unit 8.

After transmitting the behavioral data from the detector 10 to the control unit 8 at step S22, the routine returns.

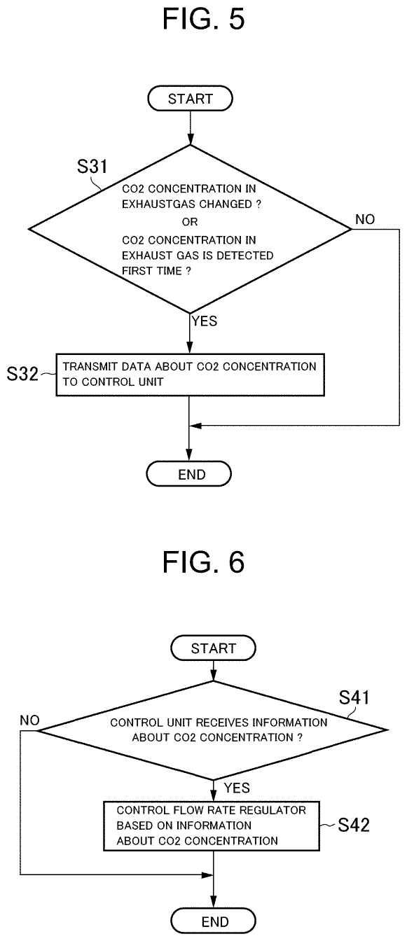

Turning to FIG. 5, there is shown an example of the routine to directly detect a concentration of CO2 in the exhaust gas emitted from the building 2. The routine shown in FIG. 5 is executed by a microcomputer (not shown) arranged in or interfacing with the CO2 sensor 9. At step S31, it is determined whether a concentration of CO2 in the exhaust gas emitted from the building 2 (or in the building 2) that is detected by the CO2 sensor 9 has changed, or whether the CO2 sensor 9 newly detects a concentration of CO2 in the exhaust gas emitted from the building 2 (or in the building 2). Specifically, at step S31, it is determined whether a concentration of CO2 in the exhaust gas that is currently detected by the CO2 sensor 9 has changed more than a predetermined value from a concentration of CO2 in the exhaust gas that is previously detected by the CO2 sensor 9. Otherwise, if a previous value of a concentration of CO2 in the exhaust gas is not available, it is determined at step S31 whether the CO2 sensor 9 detects a concentration of CO2 in the exhaust gas for the first time.

If the concentration of CO2 currently detected by the CO2 sensor 9 has not changed more than the predetermined value, or if the CO2 sensor 9 has not yet detected the concentration of CO2 so that the answer of step S31 is NO, the routine returns. By contrast, if the concentration of CO2 detected by the CO2 sensor 9 has changed more than the predetermined value, or if the CO2 sensor 9 has detected the concentration of CO2 for the first time so that the answer of step S31 is YES, the routine progresses to step S32 to transmit data about the concentration of CO2 to the control unit 8.

At step S32, specifically, the data relating to the concentration of CO2 in the exhaust gas emitted from the building 2 is transmitted from the CO2 sensor 9 to the information collector 22 of the control unit 8.

After transmitting the data relating to the concentration of CO2 from the CO2 sensor 9 to the control unit 8 at step S32, the routine returns.

Turning to FIG. 6, there is shown an example of the routine to regulate a flow rate of the exhaust gas flowing from the building 2 toward the CO2 capture device 4 or 31 based on the data collected by executing the routines shown in FIGS. 4 and 5. The routine shown in FIG. 6 is executed by the control unit 8. At step S41, it is determined whether the information collector 22 of the control unit 8 receives the behavioral data from the detector 10, or the data relating to the concentration of CO2 from the CO2 sensor 9.

If the information collector 22 has not yet received the data from the detector 10 or the CO2 sensor 9 so that the answer of step S41 is NO, the routine returns. By contrast, if the information collector 22 receives the data from the detector 10 or the CO2 sensor 9 so that the answer of step S41 is YES, the routine progresses to step S42 to regulate a flow rate of the exhaust gas flowing from the building 2 toward the CO2 capture device 4 or 31 based on the data transmitted from the detector 10 or the CO2 sensor 9.

At step S42, specifically, the flow rate regulator 7 is controlled based on the behavioral data transmitted from the detector 10 to the information collector 22, or the data relating to the concentration of CO2 transmitted from the CO2 sensor 9 to the information collector 22. For example, the flow rate regulator 7 is controlled in such a manner as to increase the flow rate of the exhaust gas flowing toward the CO2 capture device 4 or 31 with an increase in the concentration of CO2 in the exhaust gas estimated based on the behavioral data of the occupants of the building 2 detected by the detector 10, or detected directly by the CO2 sensor 9.

After regulating the flow rate of the exhaust gas flowing from the building 2 toward the CO2 capture device 4 or 31 at step S42, the routine returns.

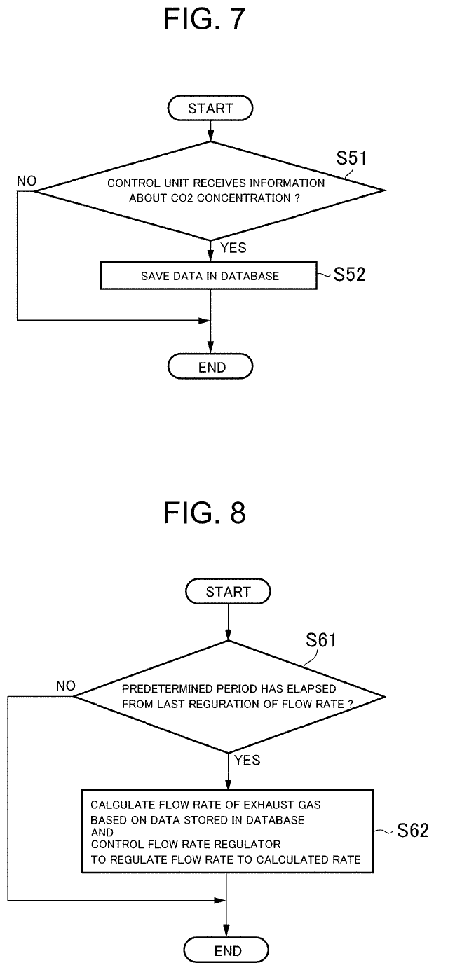

Turning to FIG. 7, there is shown an example of the routine to save the data transmitted to the control unit 8 from the detector 10 or the CO2 sensor 9. The routine shown in FIG. 7 is executed by the control unit 8 and a database interfacing with the control unit 8. The database may be installed in the control unit 8 but also in an external server. Given that the database is installed in the external server, the database is allowed to exchange data with the control unit 8. At step S51, it is determined whether the information collector 22 of the control unit 8 receives the behavioral data from the detector 10, or the data relating to the concentration of CO2 from the CO2 sensor 9.

If the information collector 22 has not yet received the data from the detector 10 or the CO2 sensor 9 so that the answer of step S51 is NO, the routine returns. By contrast, if the information collector 22 receives the data from the detector 10 or the CO2 sensor 9 so that the answer of step S41 is YES, the routine progresses to step S52 to save the data transmitted from the detector 10 or the CO2 sensor 9.

At step S52, specifically, the behavioral data transmitted from the detector 10 to the information collector 22, or the data relating to the concentration of CO2 transmitted from the CO2 sensor 9 to the information collector 22 is saved in the database.

After saving the above-mentioned data in the database, the routine returns.

Turning to FIG. 8, there is shown an example of the routine to regulate a flow rate of the exhaust gas flowing from the building 2 toward the CO2 capture device 4 or 31 based on the data stored in the database. The routine shown in FIG. 8 is also executed by the control unit 8 and the database interfacing with the control unit 8. At step S61, it is determined whether a predetermined period of time has elapsed from the last time the flow rate regulator 7 was controlled to regulate the flow rate of the exhaust gas flowing from the building 2 toward the CO2 capture device 4 or 31.

If the predetermined period of time has not yet elapsed from the last time the flow rate regulator 7 was controlled so that the answer of step S61 is NO, the routine returns. By contrast, if the predetermined period of time has elapsed from the last time the flow rate regulator 7 was controlled so that the answer of step S61 is YES, the routine progresses to step S62 to regulate a flow rate of the exhaust gas flowing from the building 2 toward the CO2 capture device 4 or 31 based on the data stored in the database.

At step S62, specifically, a flow rate of the exhaust gas flowing from the building 2 toward the CO2 capture device 4 or 31 is calculated based on the data stored in the database, and the flow rate regulator 7 is controlled based on the calculated flow rate. For example, the flow rate regulator 7 is controlled in such a manner as to increase the flow rate of the exhaust gas flowing toward the CO2 capture device 4 or 31 with an increase in the concentration of CO2 in the exhaust gas estimated based on the data stored in the database. Specifically, during the period of time in which the estimated concentration of CO2 in the exhaust gas is high, the flow rate regulator 7 is controlled in such a manner as to increase the flow rate of the exhaust gas flowing toward the CO2 capture device 4 or 31, compared to the period of time in which the estimated concentration of CO2 in the exhaust gas is low. Whereas, in a case that the estimated concentration of CO2 in the exhaust gas is lower than a predetermined value (e.g., in the case that nobody is in the building 2) the flow rate regulator 7 is controlled in such a manner as to stop the delivery of the exhaust gas to the CO2 capture device 4 or 31.

After regulating the flow rate of the exhaust gas flowing from the building 2 toward the CO2 capture device 4 or 31 at step S62, the routine returns.

Thus, in the CO2 capture system 1, the flow rate regulators 7 are arranged between the buildings 2 and the CO2 capture device(es) 4 or 31 in the smart city. According to the exemplary embodiment of the present disclosure, therefore, flow rates of the exhaust gases flowing from the buildings 2 toward the CO2 capture device(es) 4 or 31 may be regulated individually in accordance with concentrations of CO2 in the exhaust gases. For this reason, the CO2 capture device(es) 4 or 31 may be operated only when the concentrations of CO2 in the exhaust gases are high, and CO2 may be captured by the CO2 capture device(es) 4 or 31 efficiently from the exhaust gases emitted from the buildings 2.

What is claimed is:

1. A CO2 capture system, comprising:
a CO2 capture device that separates and captures CO2 from air;
a plurality of buildings;
a flow path that delivers an exhaust gas emitted from the building to the CO2 capture device to capture the CO2 from the exhaust gas by the CO2 capture device;
a flow rate regulator that regulates a flow rate of the exhaust gas flowing from the building toward the CO2 capture device through the flow path; and
a control unit that controls the flow rate regulator to regulate the flow rate of the exhaust gas.

2. The CO2 capture system as claimed in claim 1, wherein the control unit is configured to:
collect information relating to a concentration of the CO2 in the exhaust gas emitted from the building; and
control the flow rate regulator based on the collected information.

3. The CO2 capture system as claimed in claim 2, further comprising:
a detector that collects behavioral data of occupants of the building including the number of people coming in and out of the building and behavior of the people in the building,
wherein the control unit is further configured to:
receive the behavioral data of the occupants of the building; and
regulate the flow rate of the exhaust gas based on the behavioral data.

4. The CO2 capture system as claimed in claim 3, wherein the control unit is further configured to increase the flow rate of the exhaust gas with an increase in the number of the occupants of the building.

5. The CO2 capture system as claimed in claim 3, wherein the control unit is further configured to increase the flow rate of the exhaust gas during a period of time in which the number of the occupants of the building is large, compared to a period of time in which the number of the occupants of the building is small.

6. The CO2 capture system as claimed in claim 3, wherein the control unit is further configured to stop a delivery of the exhaust gas from the building to the CO2 capture device when nobody is in the building.

7. The CO2 capture system as claimed in claim 3, wherein the control unit is further configured to:
estimate the concentration of the CO2 in the exhaust gas emitted from the building based on the behavioral data of the occupants of the building; and
increase the flow rate of the exhaust gas with an increase in the concentration of the CO2 in the exhaust gas.

8. The CO2 capture system as claimed in claim 1, further comprising:
a CO2 sensor that detects a concentration of the CO2 in the exhaust gas emitted from the building,
wherein the control unit is further configured to increase the flow rate of the exhaust gas with an increase in the concentration of the CO2 in the exhaust gas detected by the CO2 sensor.

9. The CO2 capture system as claimed in claim 1,
wherein the flow rate regulator includes a valve disposed between the building and the CO2 capture device, and
the control unit is further configured to regulate the flow rate of the exhaust gas by manipulating the valve.

10. The CO2 capture system as claimed in claim 1,
wherein the flow rate regulator includes a blower disposed between the building and the CO2 capture device, and
the control unit is further configured to regulate the flow rate of the exhaust gas by controlling a wind created by the blower.
